(19) United States
(12) Patent Application Publication
(10) Pub. No.: US 2019/0155701 A1
(43) Pub. Date: May 23, 2019

(54) DYNAMIC STORAGE MAP REDIRECTION

(71) Applicant: International Business Machines Corporation, Armonk, NY (US)

(72) Inventors: Manish Motwani, Chicago, IL (US); Jason K. Resch, Chicago, IL (US); Wesley B. Leggette, Chicago, IL (US); Michael C. Storm, Palo Alto, CA (US)

(21) Appl. No.: 16/254,789

(22) Filed: Jan. 23, 2019

Related U.S. Application Data
(63) Continuation-in-part of application No. 15/804,081, filed on Nov. 6, 2017, now Pat. No. 10,223,213.
Application No. 15/804,081 is a continuation-in-part of application No. 15/276,077, filed on Sep. 26, 2016, now Pat. No. 10,083,097.
Application No. 15/276,077 is a continuation of application No. 14/215,542, filed on Mar. 17, 2014, now Pat. No. 9,456,035.
(60) Provisional application No. 61/819,039, filed on May 3, 2013.

(51) Int. Cl. G06F 11/14; G06F 16/18; G06F 16/182; H04L 29/08; G06F 11/10

(52) U.S. Cl. CPC G06F 11/1469; G06F 16/1865; G06F 16/182; G06F 2211/1028; G06F 11/1092; G06F 11/1448; H04L 67/1097

(57) ABSTRACT

A method for execution by one or more processing modules of a dispersed storage network (DSN), the method begins by migrating a DSN address sub-range from a first DS unit to a second DS unit of a set of DS units and migrating, by the second DS unit, a DSN address sub-range from the second DS unit to a third DS unit and issuing, by the third DS unit, a range owner message with regards to the DSN address sub-range to a home DS unit. The method continues by generating a DS unit access request based on a DSN address, identifying a target DS unit based on the DSN address, determining whether the target DS unit has already been identified and indicating an error when the target DS unit has not already been identified. The method continues by determining whether too many target DS units have already been identified.

### CROSS-REFERENCE TO RELATED APPLICATIONS

The present U.S. Utility patent application claims priority pursuant to 35 U.S.C. § 120 as a continuation-in-part of U.S. Utility application Ser. No. 15/804,081, entitled “SALTED ZERO EXPANSION ALL OR NOTHING TRANSFORMATION,” filed Nov. 6, 2017, which is a continuation-in-part of U.S. Utility application Ser. No. 15/276,077, entitled “STORING RELATED DATA IN A DISPERSED STORAGE NETWORK,” filed Sep. 26, 2016, now U.S. Pat. No. 10,083,097 issued on Sep. 25, 2018, which is a continuation of U.S. Utility application Ser. No. 14/215,542, entitled “STORING RELATED DATA IN A DISPERSED STORAGE NETWORK,” filed Mar. 17, 2014, now U.S. Pat. No. 9,456,035 issued on Sep. 27, 2016, which claims priority pursuant to 35 U.S.C. § 119(e) to U.S. Provisional Application No. 61/819,039, entitled “SLICE MIGRATION TRACKING IN A DISPERSED STORAGE NETWORK,” filed May 3, 2013, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9A is a schematic block diagram of an embodiment of a dispersed storage network (DSN) system in accordance with the present invention;

FIG. 9B is a flowchart illustrating an example of updating dispersed storage network (DSN) addressing in accordance with the present invention; and

FIG. 10 is a flowchart illustrating another example of updating dispersed storage network addressing in accordance with the present invention.

### DETAILED DESCRIPTION OF THE INVENTION

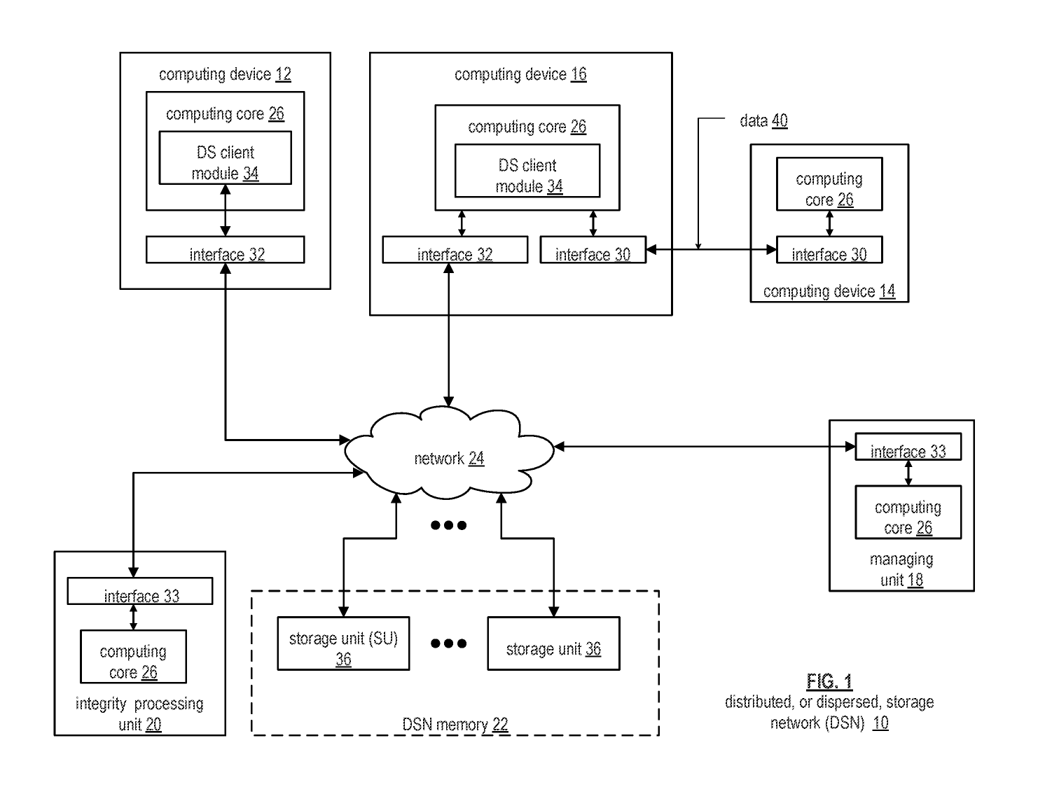

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

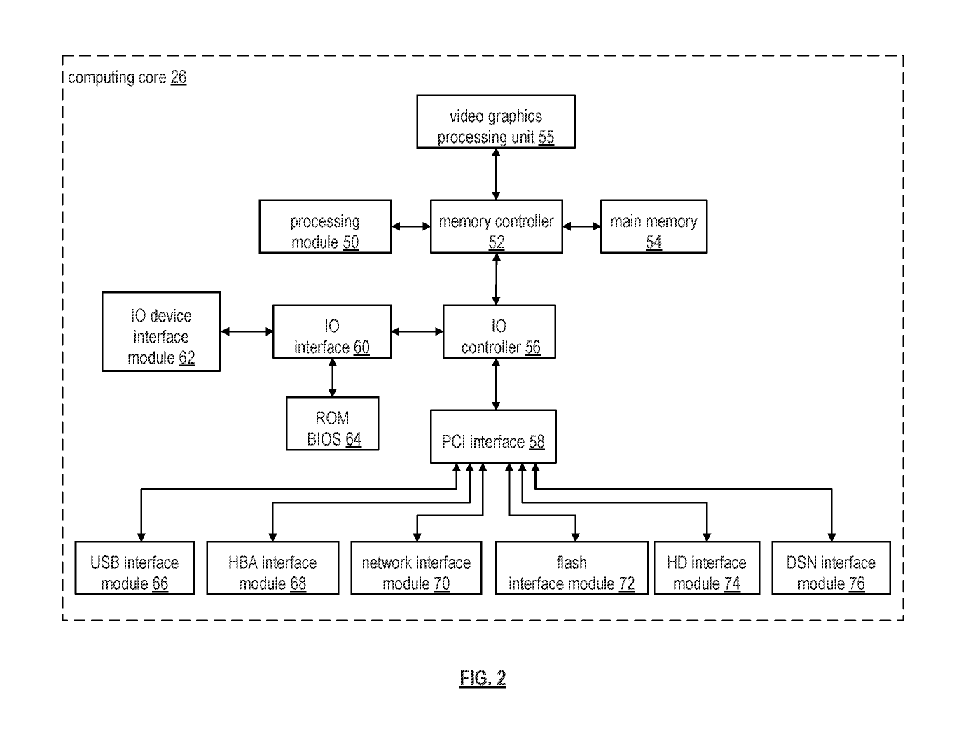

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

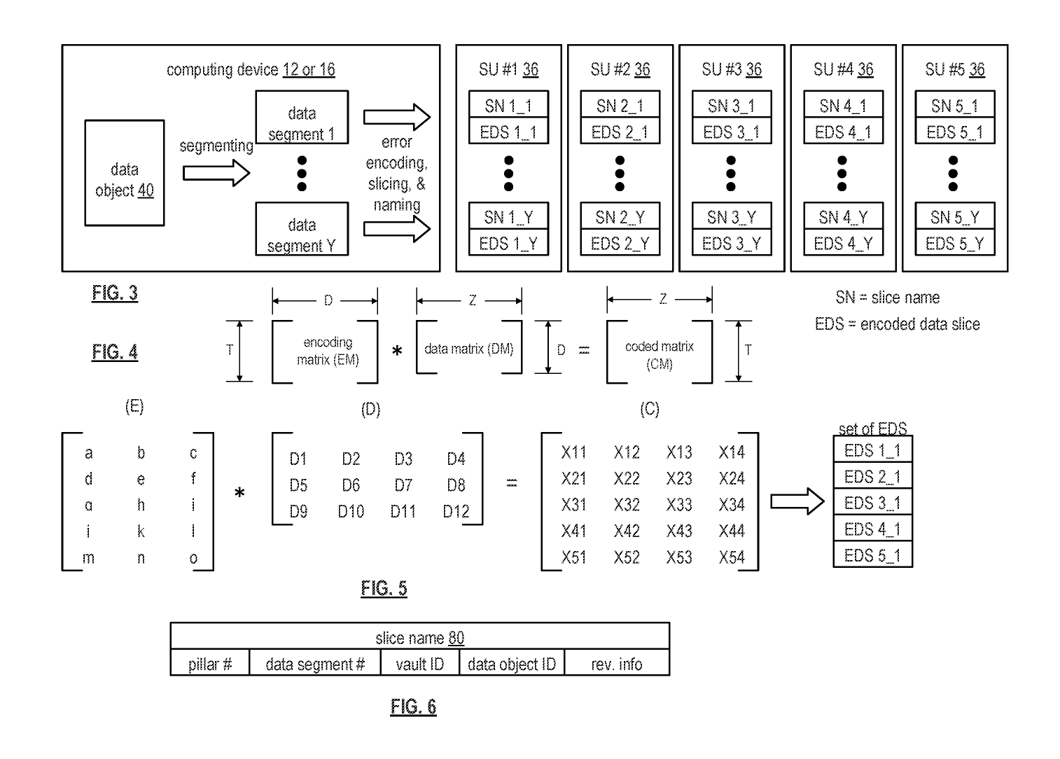

Computing devices 12 and 16 include a dispersed storage (DS) client module 34, which enables the computing device to dispersed storage error encode and decode data as subsequently described with reference to one or more of FIGS. 3-10. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSTN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSTN managing unit 18 tracks the number of times a user accesses a non-public vault and/or public vaults, which can be used to generate per-access billing information. In another instance, the DSTN managing unit 18 tracks the amount of data stored and/or retrieved by a user device and/or a user group, which can be used to generate per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSTN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an 10 interface module 60, at least one 10 device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

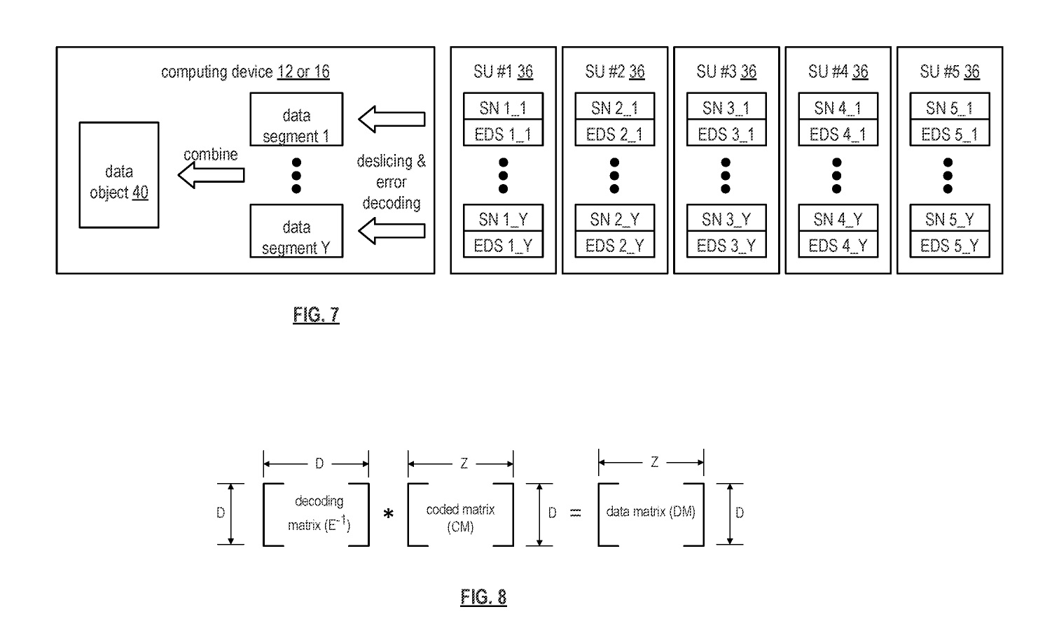

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

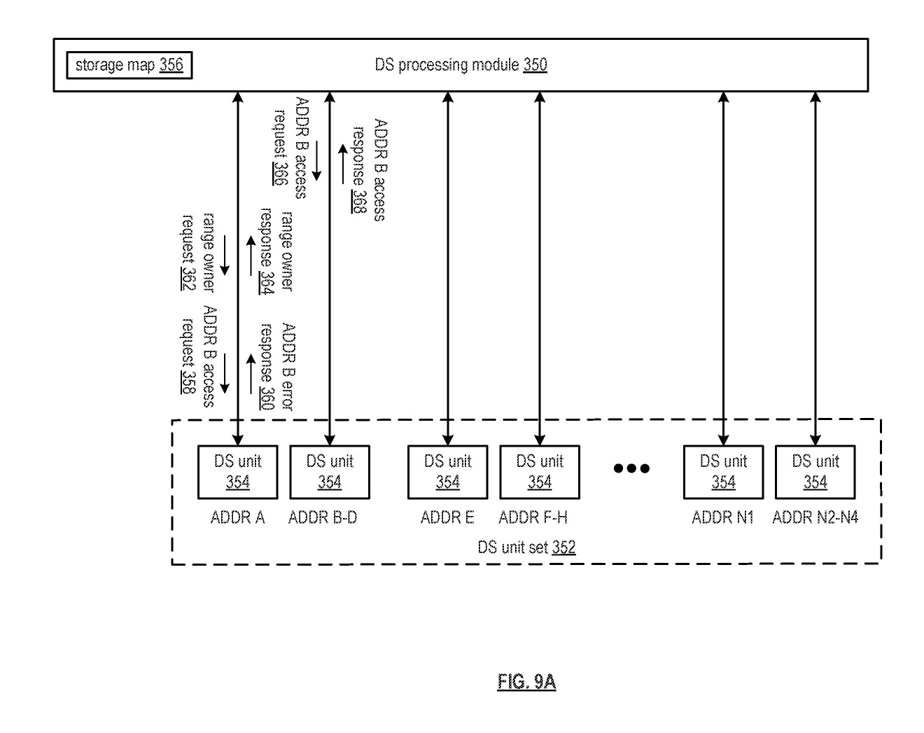

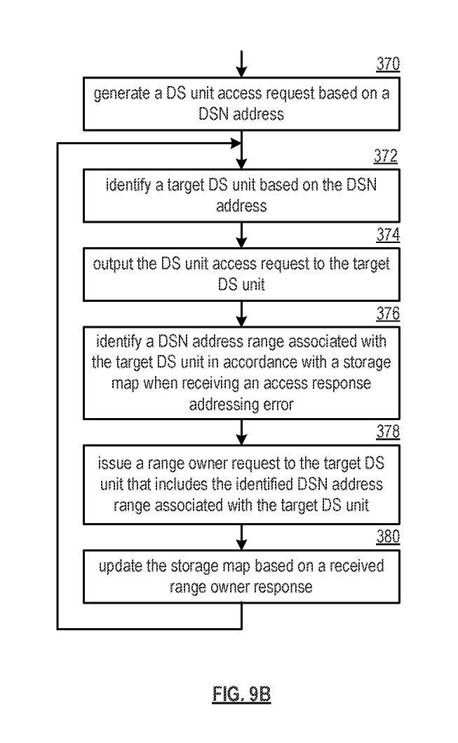

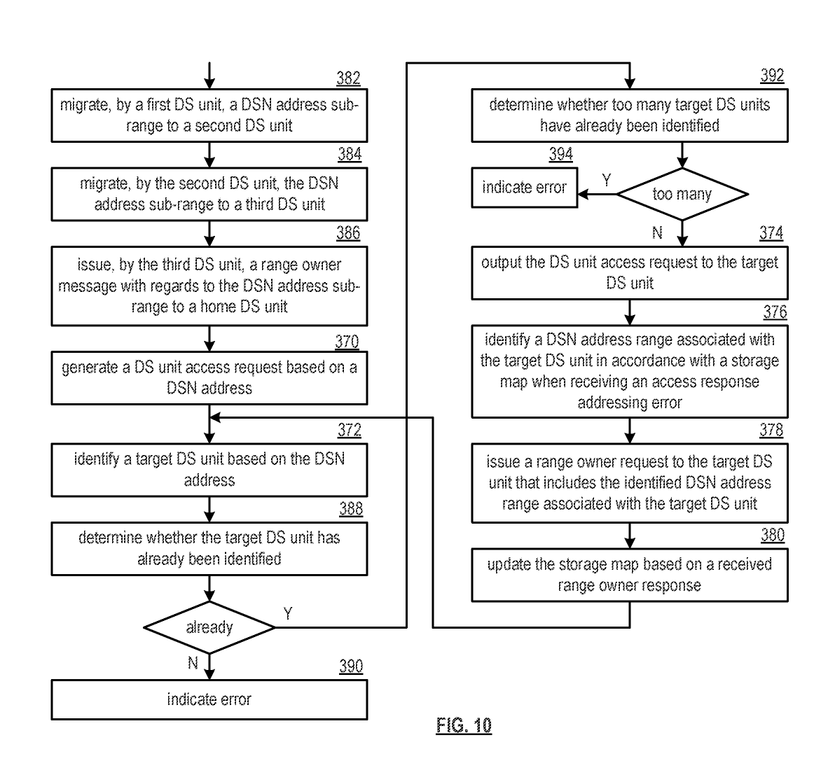

FIG. 9A is a schematic block diagram of an embodiment of a dispersed storage network (DSN) system that includes a dispersed storage (DS) processing module 350 and a DS unit set 352. The DS processing module 350 includes a memory for storage of a storage map 356. The DS processing module 350 may be implemented utilizing at least one of a DS processing unit, the distributed storage and task (DST) processing unit 16 of FIG. 1, a DST processing module, a server, a computer, a computing device, a processing module, a user device, a DS unit, a storage device, a storage server, and the DST execution unit 36 of FIG. 1. The DS unit set 352 includes a set of DS units 354. Each DS unit 354 may be implemented utilizing at least one of a storage server, a memory device, a memory module, a storage device, the DST execution unit 36 (storage unit) of FIG. 1, a user device, the DST processing unit 16 (computing device) of FIG. 1, and a DS processing unit.

The DS unit set 352 stores one or more sets of encoded data slices, where data is encoded using a dispersed storage error coding function to produce the one or more sets of encoded data slices. Each encoded data slice of the one or more sets of encoded data slices is associated with a slice name. Each DS unit 354 of the DS unit set is affiliated with one or more DSN address ranges such that the encoded data slices that correspond to the slice names within the one or more DSN address ranges are stored in the DS unit 354. For example, encoded data slices with slice names falling in DSN address range A are stored in a first DS unit 354 of the DS unit set, where the first DS unit 354 is affiliated with the DSN address range A. As another example, as illustrated, a second DS unit 354 is affiliated with address ranges B-D, a third DS unit 354 is affiliated with address range E, a fourth DS unit 354 is affiliated with address ranges F-H, etc. through a second to last DS unit 354 affiliated with address range N1 and a last DS unit 354 affiliated with address ranges N2-N4.

The storage map 356 includes a mapping of the one or more DSN address ranges for each DS unit 354. The DS processing module 350 utilizes the storage map 356 when accessing one or more encoded data slices stored in the DS unit set 352. For example, when accessing an encoded data slice associated with a slice name within DSN address range A, the DS processing module 350 sends an access request to the first DS unit 354 when the storage map indicates that the first DS unit 354 is associated with the DSN address range A. The storage map 356 may be initially generated using a deterministic function such that DSN address ranges are evenly distributed amongst the set of DS units such that each DS unit 354 of the set of DS units is affiliated with a common number of DSN addresses of a corresponding DSN address range.

From time to time, DS unit to DSN address range affiliations may be updated. At least one of the DS processing module 350 and at least one DS unit 354 of the set of DS units may determine to update the DS unit to DSN address range affiliation. The determining may be based on one or more of detecting a storage imbalance between two DS units of the set of DS units, receiving an error message, detecting DS unit unavailability, a predetermination, interpreting a schedule, and receiving a request. For example, the first DS unit 354 determines to migrate address range B from the first DS unit 354 to the second DS unit 354 when encoded data slices stored in the first DS unit are utilizing a greater amount of storage capacity as compared to encoded data slices stored in the second DS unit. When migrating the address range B from the first DS unit 354 to the second DS unit 354, each of the first DS unit and the second DS unit update a corresponding local storage map to indicate that DSN address range B is affiliated with the second DS unit and is to be de-affiliated from the first DS unit. Alternatively, or in addition to, at least one of the first DS unit 354 and the second DS unit 354 updates the DS processing module 350 to affect updating of the storage map 356 stored within the DS processing module.

In an example of operation, the DS processing module 350 issues a DSN address range B access request 358 that includes a slice name (e.g., a read or write request for an encoded data slice associated with the slice name that falls within the DSN address range B) to the first DS unit 354 in accordance with the storage map of the DS processing module 350 (e.g., when the slice name falls within DSN address range B and the storage map indicates that the DSN address range B is affiliated with the first DS unit). The first DS unit 354 detects an addressing error by determining that the slice name of the DSN address range B access request is not affiliated with the first DS unit (e.g., since the slice name is affiliated with the second DS unit in accordance with the local storage map of the first DS unit). When detecting such an addressing error, the first DS unit 354 issues a DSN address range B error response 360 to the DS processing module 350, where the DSN address range B error response 360 includes an indicator that the encoded data slice of the slice name of the DSN address range B request is not associated with the first DS unit. When receiving the DSN address range B error response 360, the DS processing module 350 identifies a DSN address range associated with the slice name to produce an identified DSN address range. The determining includes one or more of accessing the storage map 356, initiating a query, receiving a response, and interpreting an error message. For example, the DS processing module 350 accesses the storage map 356 to identify DSN address range B as associated with the slice name.

Next, the DS processing module 350 issues a range owner request 362 to the first DS unit in accordance with the storage map 356, where the range owner request includes the identified DSN address range B. The first DS unit 354 accesses the local storage map of the first DS unit to identify one or more DS units associated with the identify DSN address range B. For instance, the first DS unit 354 identifies the second DS unit 354 as associated with the DSN address range B. The first DS unit 354 issues a range owner response 364 to the DS processing module 350, where the range owner response 364 includes identity of the second DS unit as associated with the DSN address range B. The DS processing module 350 receives the range owner response 364 and updates the storage map 356 of the DS processing module 350 to indicate that the DSN address range B is affiliated with the second DS unit 354 and is de-affiliated with the first DS unit 354.

Next, the DS processing module 350 issues another DSN address range B access request 366 that includes the slice name to the second DS unit in accordance with the storage map 356 of the DS processing module 350 (e.g., when the slice name falls within DSN address range B and the storage map indicates that the DSN address range B is affiliated with the second DS unit). The second DS unit 354 receives the DSN address range B access request 366, and upon verifying that the slice name is associated with the second DS unit based on the storage map of the second DS unit, issues a DSN address range B access response 368 to the DS processing module 350 based on the DSN address range B access request. For example, the DSN address range B access response 368 includes the encoded data slice when the DSN address range B access request 366 includes a read request. As another example, the DSN address range B access response 368 includes a status indicator when the DSN address range B access request 366 includes a write request. The status indicator may include one of a write error indicator and a write success indicator.

FIG. 9B is a flowchart illustrating an example of updating dispersed storage network (DSN) addressing. The method begins at step 370 where a processing module (e.g., of a distributed storage and task (DST) client module, of a dispersed storage (DS) processing module) generates a DS unit access request based on a DSN address. The generating includes determining the DSN address based on one or more of a directory lookup, a dispersed hierarchical index lookup, and generating (e.g., when writing new data). The generating further includes generating a slice name based on the DSN address for inclusion in the DSN access request. The method continues at step 372 where the processing module identifies a target DS unit based on the DSN address. The identifying includes one or more of a storage map lookup, identifying a DSN address range associated with the DSN address based on the storage map lookup, identifying the DSN address range associated with the slice name based on the storage map lookup, and identifying the target DS unit based on the storage map lookup using at least one of the DSN address range, the DSN address, and a slice name.

The method continues at step 374 where the processing module outputs the DS unit access request to the target DS unit. The method continues at step 376 where the processing module identifies a DSN address range associated with the target DS unit in accordance with the storage map when receiving an access response addressing error. The identifying includes receiving the access response addressing error and identifying a DSN address range associated with the DS unit based on the storage map lookup.

The method continues at step 378 where the processing module issues a range owner request to the target DS unit that includes the identified DSN address range associated with the target DS unit. The issuing includes generating the range owner request and outputting the range owner request to the target DS unit. The method continues at step 380 where the processing module updates the storage map based on received range owner response. The range owner response may include one or more DS unit identifiers and a corresponding one or more DSN address ranges. The updating includes, for each DS unit identifier of the one or more DS unit identifiers of the range owner response, updating the storage map for each of the one or more DS unit identifiers to include a corresponding one or more address ranges of the range owner response, where the address ranges fall within the DSN address range associated with the DS unit. As such, the processing module may ignore DSN address mappings outside of the identified DSN address range.

FIG. 10 is a flowchart illustrating another example of updating dispersed storage network addressing, which includes similar steps to FIG. 9B. In particular, a method is presented for use in conjunction with one or more functions and features described in conjunction with FIGS. 1-2, 3-8, 9A, 9B and also FIG. 10.

The method begins at step 382 where a first dispersed storage (DS) unit of a set of DS units migrates a dispersed storage network (DSN) address sub-range from the first DS unit to a second DS unit of the set of DS units. The migrating includes one or more of selecting slices to migrate, identifying an DSN address sub-range associated with the selected slices based on a local storage map of the first DS unit, facilitating migration of the slices, updating the local storage map associated with the first DS unit to affiliate the DSN address sub-range with the second DS unit and to de-affiliate the DSN address sub-range with the first DS unit.

The method continues at step 384 where the second DS unit migrates the DSN address sub-range from the second DS unit to a third DS unit. The migrating includes one or more of selecting slices to migrate, identifying the DSN address sub-range associated with the selected slices based on a local storage map of the second DS unit, facilitating migration of the slices, updating the local storage map associated with the second DS unit to affiliate the DSN address sub-range with the third DS unit and to de-affiliate the DSN address sub-range with the second DS unit.

The method continues at step 386 where the third DS unit issues a range owner message with regards to the DSN address sub-range to a home DS unit. The home DS unit includes a DS unit affiliated with the DSN address sub-range with regards to a storage map of a DS processing module. For example, the home DS unit includes the first DS unit. The issuing includes generating and outputting the range owner message to one or more of the second DS unit, the first DS unit, or one or more DS processing modules including the DS processing module. The method continues with steps 370-372 of FIG. 9B where a processing module (e.g., of a distributed storage and task (DST) client module, of a dispersed storage (DS) processing module) generates a DS unit access request based on a DSN address and identifies a target DS unit based on the DSN address.

The method continues at step 388 where the processing module determines whether the target DS unit has already been identified. The determining may be based on a tracking record that tracks previous authentication of potential target DS units. The method continues to step 390 when the target DS unit has not already been identified. The method branches to step 392 when the target DS unit has already been identified. The method continues at step 390 where the processing module indicates an error when the target DS unit has not already been identified. The indicating of the error includes at least one of issuing a namespace error message to one or more of a requesting entity, the DS processing module, and a DS managing unit.

When the target DS unit has already been identified, the method continues at step 392 where the processing module determines whether too many target DS units have already been identified. The determining may be based on a tracking record associated with tracking how many target DS units have been accessed. The method branches to step 374 of FIG. 9B when too many target DS units have not already been identified. The method continues to step 394 when too many target DS units have already been identified. When too many steps have already been identified, the method continues at step 394 where the processing module indicates the error.

When too many target DS units have not already been identified, the method continues with steps 374-380 of FIG. 9B where the processing module outputs the DS unit access request to the target DS unit, identifies a DSN address range associated with the target DS unit in accordance with a storage map when receiving an access response addressing error, issues a range owner request to the target DS unit that includes the identified DSN address range associated with the target DS unit, and updates the storage map based on a received range owner response. The method branches back to step 372 of FIG. 9B where the processing module identifies the target DS unit based on the DSN address.

The method described above in conjunction with the processing module can alternatively be performed by other modules of the dispersed storage network or by other computing devices. In addition, at least one memory section (e.g., a non-transitory computer readable storage medium) that stores operational instructions can, when executed by one or more processing modules of one or more computing devices of the dispersed storage network (DSN), cause the one or more computing devices to perform any or all of the method steps described above.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of one or more computing devices of a dispersed storage network (DSN), the method comprises:
migrating, by a first dispersed storage (DS) unit, a dispersed storage network (DSN) address sub-range from the first DS unit to a second DS unit of a set of DS units;
migrating, by the second DS unit, the DSN address sub-range from the second DS unit to a third DS unit; and
issuing, by the third DS unit, a range owner message with regards to the DSN address sub-range to a home DS unit.

2. The method of claim 1 further comprises:
generating a DS unit access request based on a DSN address;
identifying a target DS unit based on the DSN address;
determining whether the target DS unit has already been identified; and
indicating an error when the target DS unit has not already been identified.

3. The method of claim 2, wherein the determining whether the target DS unit has already been identified is based on a tracking record that tracks previous authentication of potential target DS units.

4. The method of claim 2, wherein the indicating of the error includes at least one of: issuing a namespace error message to one or more of a requesting entity, a DS processing module, or a DS managing unit.

5. The method of claim 2 further comprises determining whether too many target DS units have already been identified and indicating the error when too many target DS units have already been identified.

6. The method of claim 2 further comprises:
determining whether too many target DS units have already been identified and
when too many target DS units have not already been identified, outputting the DS unit access request to the target DS unit, identifying a DSN address range associated with the target DS unit in accordance with a storage map when receiving an access response addressing error, issuing a range owner request to the target DS unit that includes the identified DSN address range associated with the target DS unit, updating the storage map based on a received range owner response and identifying the target DS unit based on the DSN address.

7. The method of claim 6, wherein the determining whether too many target DS units have already been identified is based on a tracking record associated with tracking how many target DS units have been accessed.

8. The method of claim 1, wherein the migrating includes: selecting slices to migrate, identifying the DSN address sub-range associated with the selected slices to migrate based on a local storage map of the first DS unit, facilitating migration of the slices, updating the local storage map associated with the first DS unit to affiliate the DSN address sub-range with the second DS unit and to de-affiliate the DSN address sub-range with the first DS unit.

9. The method of claim 1, wherein the migrating includes one or more of: selecting slices to migrate, identifying the DSN address sub-range associated with the selected slices to migrate based on a local storage map of the second DS unit, facilitating migration of the slices, updating the local storage map associated with the second DS unit to affiliate the DSN address sub-range with the third DS unit and to de-affiliate the DSN address sub-range with the second DS unit.

10. The method of claim 1, wherein the home DS unit includes a DS unit affiliated with the DSN address sub-range with regards to a storage map of a DS processing module.

11. The method of claim 1, wherein the home DS unit includes the first DS unit and the issuing includes generating and outputting the range owner message to one or more of: the second DS unit, the first DS unit, or one or more DS processing modules including the DS processing module.

12. A computing device of a group of computing devices of a dispersed storage network (DSN), the computing device comprises:
an interface;
a local memory; and
a processing module operably coupled to the interface and the local memory, wherein the processing module functions to:
migrate, by a first DS (dispersed storage) unit, a dispersed storage network (DSN) address sub-range from the first DS unit to a second DS unit of a set of DS units;
migrate, by the second DS unit, a DSN address sub-range from the second DS unit to a third DS unit; and
issue, by the third DS unit, a range owner message with regards to the DSN address sub-range to a home DS unit.

13. The computing device of claim 12, wherein the processing module is further configured to:
generate a DS unit access request based on a DSN address;
identify a target DS unit based on the DSN address;
determine whether the target DS unit has already been identified; and
indicate an error when the target DS unit has not already been identified.

14. The computing device of claim 13, wherein the determine whether the target DS unit has already been identified is based on a tracking record that tracks previous authentication of potential target DS units.

15. The computing device of claim 13, wherein the indicate an error includes at least one of: issuing a namespace error message to one or more of a requesting entity, a DS processing module, or a DS managing unit.

16. The computing device of claim 13, wherein the processing module is further configured to:
determine whether too many target DS units have already been identified and
when too many target DS units have not already been identified, output the DS unit access request to the target DS unit, identify a DSN address range associated with the target DS unit in accordance with a storage map when receiving an access response addressing error, issue a range owner request to the target DS unit that includes the identified DSN address range associated with the target DS unit, and update the storage map based on a received range owner response and identifying the target DS unit based on the DSN address.

17. The computing device of claim 16, wherein the processing module is further configured to:
determine whether too many target DS units have already been identified and indicate the error when too many target DS units have already been identified.

18. The computing device of claim 12, wherein the migrating includes one or more of: selecting slices to migrate, identifying DSN address sub-range associated with the selected slices to migrate based on a local storage map of the first DS unit, facilitating migration of the slices, updating the local storage map associated with the first DS unit to affiliate the DSN address sub-range with the second DS unit and to de-affiliate the DSN address sub-range with the first DS unit.

19. The computing device of claim 12, wherein the home DS unit includes a DS unit affiliated with the DSN address sub-range with regards to a storage map of a DS processing module.

20. A system comprises:
an interface;
a local memory;
dispersed storage network (DSN); and
a processing module operably coupled to the interface, the local memory and the DSN, wherein the processing module functions to:
migrate, by a first DS (dispersed storage) unit, a dispersed storage network (DSN) address sub-range from the first DS unit to a second DS unit of a set of DS units;
migrate, by the second DS unit, a DSN address sub-range from the second DS unit to a third DS unit;
issue, by the third DS unit, a range owner message with regards to the DSN address sub-range to a home DS unit;
generate a DS unit access request based on a DSN address;
identify a target DS unit based on the DSN address;
determine whether the target DS unit has already been identified; and
indicate an error when the target DS unit has not already been identified.
